(19) United States
(12) Patent Application Publication
(10) Pub. No.: US 2008/0101271 A1
(43) Pub. Date: May 1, 2008

(54) Apparatus and method for multicast and broadcast service (MBS) in broadband wireless access (BWA) system

(75) Inventors: Jae-Woo Kwon, Suwon-si (KR); Ki-Back Kim, Seongnam-si (KR); Sung-Bum Park, Seongnam-si (KR)

Correspondence Address: DOCKET CLERK, P.O. DRAWER 800889, DALLAS, TX, 75380, US

(73) Assignee: SAMSUNG ELECTRONICS CO., LTD., Suwon-si (KR)

(21) Appl. No.: 11/981,987

(22) Filed: Oct. 31, 2007

(30) Foreign Application Priority Data
Oct. 31, 2006 (KR) 2006-0106221

(51) Int. Cl. H04H 20/71

(52) U.S. Cl. 370/312

(57) ABSTRACT

Apparatus and method for multicast and broadcast service (MBS) in a broadband wireless access (BWA) system. The terminal state managing method includes examining whether a dormant timer of a terminal managed in an awake mode expires or not; when the dormant timer expires, examining whether the terminal receives a broadcast service; and when the terminal receives the broadcast service, managing the terminal in a fake awake mode.

### CROSS-REFERENCE TO RELATED APPLICATION(S) AND CLAIM OF PRIORITY

The present application claims priority under 35 U.S.C. § 119 (a) to an application filed in the Korean Intellectual Property Office on Oct. 31, 2006 and assigned Serial No. 2006-0106221, the contents of which are herein incorporated by reference.

### TECHNICAL FIELD OF THE INVENTION

The present application relates generally to an apparatus and method for Multicast and Broadcast Service (MBS) in a Broadband Wireless Access (BWA) system, and in particular, to an apparatus and method for providing MBS and unicast service at the same time in the BWA system.

### BACKGROUND OF THE INVENTION

In general, communication systems have been developed based on a voice service and are now advancing to providing data service and various multimedia services as well as the voice service. The voice oriented communication systems have not satisfied users' service needs because of their relatively narrow transmission bandwidths and expensive fees. Additionally, advances of the communication industry and users' increasing demand for Internet service raise the necessity for communication systems that efficiently provide Internet service. To respond to this demand, a Broadband Wireless Access (BWA) system is presented with enough broadband to meet the users' increasing demand for an efficiently provided Internet service.

The BWA system integrally supports not only a voice service, but also multimedia application services such as various low- and high-speed data services and high-definition video. The BWA system is a radio communication system capable of accessing a Public Switched Telephone Network (PSTN), a Public Switched Data Network (PSDN), the Internet, an International Mobile Telecommunications (IMT)-2000 network, and an Asynchronous Transfer Mode (ATM) network in a mobile or stationary environment based on radio media using broad bands of 2 GHz, 5 GHz, 26 GHz, and 60 GHz, and supporting a data transfer rate over 2 Megabits per second (Mbps). The BWA system can be classified to a broadband wireless subscriber network, a broadband mobile access network, and a high-speed wireless Local Area Network (LAN) based on the terminal mobility (stationary or mobile), the communication environment (indoor or outdoor), and the channel transfer rate.

The BWA system is standardized by Institute of Electrical and Electronics Engineers (IEEE) 802.16 Working Group, which is an international standardization organization.

Compared to a conventional radio technique for the voice service, the IEEE 802.16 standard can transfer much data within a shorter time with the wide data bandwidth and allow all users to efficiently share and utilize the channel (or resource). Also, with Quality of Service (QoS) guaranteed, the users can enjoy services of different qualities according to the service characteristics.

Main services of the BWA system include Internet, Voice over Internet Protocol (VoIP), non-real time streamlining service, and so on. Recently, a real-time broadcast service, Multicast and Broadcast Service (MBS), was introduced as a new service. The MBS can support mobility similar to Digital Multimedia Broadcasting (DMB) and service more channels at the same time.

When a BWA system provides the MBS, there can be subscribers using only the unicast service and subscribers receiving only the MBS. At this time, disadvantageously, the subscriber capacity of the system is limited, which is described in detail.

FIG. 1 depicts state transition of a terminal in a conventional BWA system.

In FIG. 1, the terminal state includes a null mode 101, an awake mode 103, a sleep mode 105, and an idle mode 107. The state transition is performed in a Base Station (BS) as well as in the terminal.

The null mode 101 in FIG. 1 signifies the power off of the terminal. When the terminal is powered on, it transits to the awake mode 103 after setting a radio section connection. The awake mode 103 signifies the mode for transmitting and receiving data.

After entering the awake mode 103, the terminal, which intends to receive the MBS requests, requests broadcast contents to an MBS Controller (MBSC) and receives the broadcast contents from the MBSC. If a terminal user does not finish the MBS, the terminal operates in the awake mode 103.

When there is no traffic over a certain time (sleep time) after the MBS end, the terminal changes from the awake mode 103 to the sleep mode 105. After entering the sleep mode 105, the terminal examines whether there is traffic after an idle timer expires. Upon detecting the traffic, the terminal goes back to the awake mode 103 to transmit and receive the traffic. The terminal can examine whether there is traffic or not from a Traffic Indication (TRF-IND) message received over a listening interval of the sleep mode 105.

When there is no traffic until the idle timer expires, the terminal transits to the awake mode 103 to exchange message with the BS and then enters the idle mode 107. Specifically, the terminal changes to the awake mode 103 to release the connection with the BS and then enters the idle mode 107. The idle mode 107 is the mode which releases the radio section connection while keeping Service Flow (SF) information. After entering the idle mode 107, the terminal examines whether there is an incoming traffic at regular time intervals. Upon detecting the incoming traffic, the terminal goes back to the awake mode 103 to transmit and receive the traffic. The terminal can determine whether there is traffic from a Paging Advertisement (PAG-ADV) message received over a listening interval of the idle mode 107. As above, the sleep timer and the idle timer manage both of the system (BS system) and the terminal. When the timer of either the system or the terminal expires, the mode transition to the correspondent node is requested. When the correspondent node approves the transition, both of the system and the terminal transit to the same mode. If the correspondent mode does not approve the transition, the mode transition is infeasible.

As discussed above, in the related art, the terminal receiving the MBS needs to operate in the awake mode or the active mode all the time. In general, the BWA communication system restricts the maximum number of terminals in the awake mode because of the allocation limitation of Channel Quality Indicator (CQI) channel. In other words, the system needs to allocate a CQI channel to the active terminal. Yet, since the number of CQI channels allocated by the system is limited, the number of the active terminals is also limited.

The terminal receiving only the MBS receives the broadcast contents using preset resources. That is, since the terminal does not have to schedule the resources, the CQI channel allocation is unnecessary. However, in the related art, since the terminals receiving only the MBS are classified as awake-mode terminals, the number of the active terminals may be saturated because of the MBS receiving terminals. For instance, when a new terminal attempts to access, the system may reject the access because of the MBS receiving terminals, even through the system is able to accept the new terminal. When the MBS and the unicast service are provided at the same time, it is necessary to separately manage the MBS receiving terminals.

### SUMMARY OF THE INVENTION

To address the above-discussed deficiencies of the prior art, it is a primary aspect of the present invention to substantially solve at least the above problems and/or disadvantages and to provide at least the advantages below. Accordingly, an aspect of the present invention is to provide a state transition of a terminal in consideration of a multicast and broadcast service (MBS) in a broadband wireless access (BWA) system.

Another aspect of the present invention is to provide an apparatus and method for separately managing a terminal receiving only the MBS among terminals transceiving traffic in a BWA system.

Yet another of the present invention is to provide an apparatus and method for providing MBS and unicast service at the same time in a BWA system.

The above aspects are achieved by providing a terminal state managing method in a Broadband Wireless Access (BWA) system, which includes examining whether a dormant timer of a terminal managed in an awake mode expires or not; when the dormant timer expires, examining whether the terminal receives a broadcast service; and when the terminal receives the broadcast service, managing the terminal in a fake awake mode.

According to one aspect of the present invention, a Base Station (BS) in a BWA system includes a timer manager for operating a dormant timer for terminals respectively; and a state manager for managing a mode of the terminals, examining whether a corresponding terminal receives a broadcast service when the dormant timer expires, and managing the terminal in a fake awake mode when the terminal receives the broadcast service.

According to another aspect of the present invention, an operating method of a BS in a BWA system includes classifying terminals receiving only a broadcast service to a fake awake mode and other terminals to an awake mode among terminals having traffic; and when an access of a new terminal is detected, determining whether to admit a connection based on a number of terminals in the awake mode.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 depicts state transition of a terminal in a conventional BWA system;

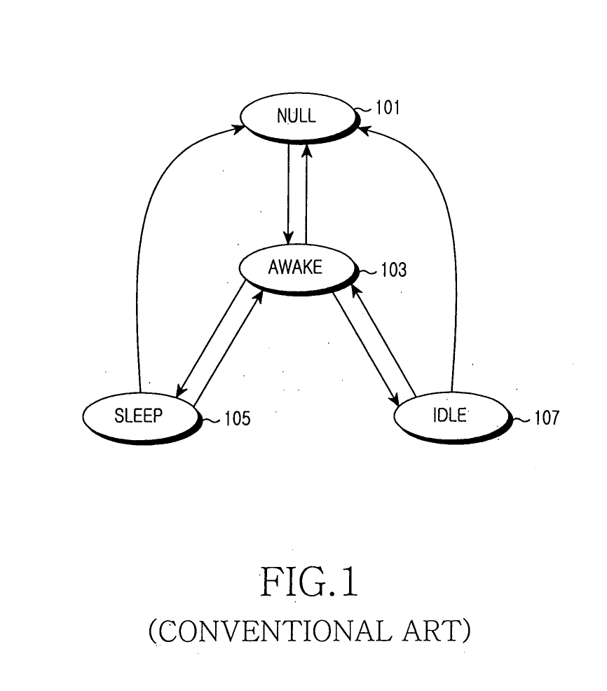

FIG. 2 depicts a network configured to provide MBS according to the present invention;

FIG. 3 depicts state transition of a terminal in a BWA system according to the present invention;

FIG. 4 is a flowchart of operations of a BS in the BWA system according to the present invention;

FIG. 5 is a flowchart of operations of the BS in the BWA system according to the present invention; and

FIG. 6 is a block diagram of the BS according to the present invention.

### DETAILED DESCRIPTION OF THE INVENTION

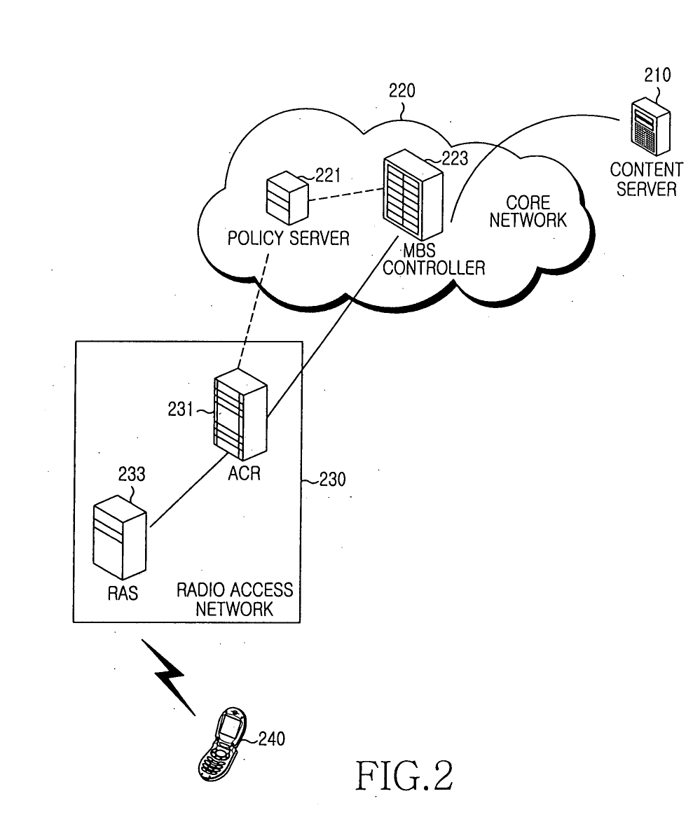

FIGS. 2 through 6, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication system.

The present invention provides a terminal state operating method by considering a multicast and broadcast service (MBS) in a broadband wireless access (BWA) system. When there are terminals receiving a unicast service and terminals receiving the MBS, among the terminals actually transceiving traffic, terminals receiving only the MBS are managed in a fake awake mode and the other terminals are managed as an awake-mode terminal. When a base station (BS) detects the access of a new terminal, it performs a connection admission control (CAC) based on the number of the awake-mode terminals.

In the following explanations, a name of a network entity (NE) is defined according its corresponding function and thus may vary according to an intention of a standard group or an operator. For example, the BS can be called a radio access station (RAS) and a BS controller can be called an access control router (ACR) or access service network-gateway (ASN-GW). Herein, the ASN-GW can function as not only the BS controller but also a router. Also, The broadcast service can be called a Multicast and Broadcast Service (MBS) or a MultiCast BroadCast Service (MCBCS) according to an intention of standard group or an operator.

FIG. 2 depicts a network configured to provide a multicast and broadcast service (MBS) according to the present invention.

The network includes a content server 210, a core network (CN) 220, a radio access network 230, and a terminal 240. The CN 220 includes a policy server 221 and an MBS controller 223. The radio access network 230 includes an ACR 231 and an RAS 223.

The content server 210 in FIG. 2 stores contents provided from Content Provider (CP) (not illustrated), and provides the corresponding contents to the MBS controller 223 according to a service guide. The content server 210 can be called a MCBCS Application Server (AP) according to an intention of standard group or an operator.

The policy server 221 manages Quality of Service (QoS) information based on Internet Protocol (IP) flows. When the MBS is triggered for a specific terminal, the policy server 221 provides triggering information to the BS system (the ACR and the RAS) through a Computer Oracle and Password System (COPS) interface. Detailed operations of the policy server 221 are not directly related to the present invention and shall be omitted.

When a service request is received from the terminal 240, the MBS controller 223 notifies the policy server 221 of the service request. The MBS controller 223 receives the corresponding broadcast contents (or the broadcast traffic) from the content server 210 according to a broadcast schedule (or service guide) and forwards the contents to the terminal 240 via the ACR 231 and the RAS 223. The MBS controller 223 can be called MCBCS Network Server (NS) according to an intention of standard group or an operator.

The ACR 231 forwards the broadcast contents from the MBS controller 223 to the RAS 233. The ACR 231 manages connection and mobility of the terminal 240, and generates unique Service Flows (SFs) for uplink and downlink connections. For example, when the MBS triggering for the terminal 240 is notified from the policy server 221, the ACR 231 generates an SF to provide the MBS to the terminal 240. Therefore, The ACR 231 comprises a software block (eg, a MCBCS controller) for processing a broadcasting service.

The RAS 233 forwards the broadcast contents from the ACR 231 to the terminal 240. The RAS 233 is connected to the ACR 231 by cable and connected to the terminal 240 by radio. The RAS 233 allocates a resource to the terminal 240 by scheduling based on Media Access Control (MAC) layer QoS.

The RAS 233 manages state of the connected terminals individually. Among terminals transceiving actual traffic, the RAS 233 manages a terminal receiving only the MBS as a fake awake mode terminal and manages other terminals as awake mode terminals. When detecting the access of a new terminal, the RAS 233 performs CAC based on the number of terminals in the awake mode.

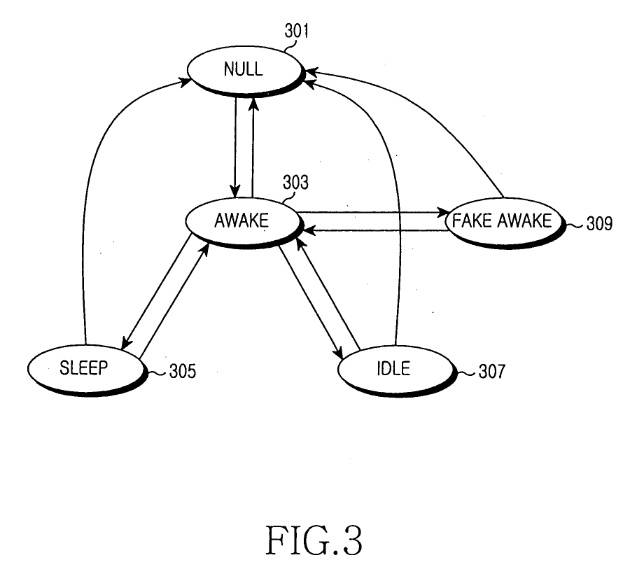

FIG. 3 depicts state transition of a terminal in a broadband wireless access (BWA) system according to the present invention.

The terminal state in FIG. 3 includes a null mode 301, an awake mode 303, a sleep mode 305, an idle mode 307, and a fake awake mode 309. The state transition of the terminal is the same as in the BS.

The null mode 301 signifies the power off of the terminal. When the terminal is powered on, the terminal and the RAS establish a radio section connection and then transit to the awake mode 303. The awake mode 303 signifies that the RAS and the terminal actually transceive data. After entering the awake mode 303, the terminal which intends to receive the MBS requests broadcast contents to the MBS controller and receives the broadcast contents from the MBS controller. When there is no traffic relating to the unicast connection in the awake mode 303, a sleep timer and an idle timer operate. In general, the time of the idle timer is longer than that of the sleep timer.

In the awake mode 303, the RAS examines whether the sleep timer for the unicast connection expires. The sleep timer expires when there is no traffic for the unicast connection over a certain time. When the sleep timer expires, the RAS determines whether the terminal is receiving the MBS. If so, the terminal state is changed from the awake mode 303 to the fake awake mode 309. Like the RAS, the terminal can transit to the fake awake mode 309 or stay in the awake mode 303. When the terminal stays in the awake mode, the RAS can operate the sleep timer for the unicast connection and the terminal can operate regardless of the service.

When the MBS is finished or the unicast traffic (uplink or downlink traffic) is generated in the fake awake mode 309, the RAS changes the terminal state from the fake awake mode 309 to the awake mode 303. When there is no traffic for a certain time (the sleep time) for the unicast connection even after the MBS ends, the RAS changes the terminal state from the awake mode 303 to the sleep mode 305.

In the sleep mode 305, the RAS and the terminal examine whether the idle timer expires. When detecting the traffic before the idle timer expires, the RAS and the terminal return to the awake mode 303 to transceive the traffic.

When there is no traffic until the idle timer expires, the RAS and the terminal transit to the awake mode 303, exchange messages, and then enter the idle mode 307. That is, the RAS and the terminal release the radio section connection in the awake mode 303 and change to the idle mode 307. The idle mode 307 signifies that the radio section connection is released but the SF information is maintained. In the idle mode 307, the terminal examines whether there is incoming traffic at regular time intervals. When detecting the incoming traffic, the RAS and the terminal transit the awake mode 303 and transceive the traffic.

According to the state transition (or the mode transition) as above, the RAS separately manages the terminals receiving only the MBS in the fake awake mode 309. Hence, it is possible to restrict the awake mode 303 to terminals which actually receive the unicast service. In doing so, the RAS can perform the CAC based on the number of terminals which actually receive the unicast service.

In the state transition, the sleep mode 305 and the idle mode 307 are the standby states without traffic, and are often known as a dormant mode.

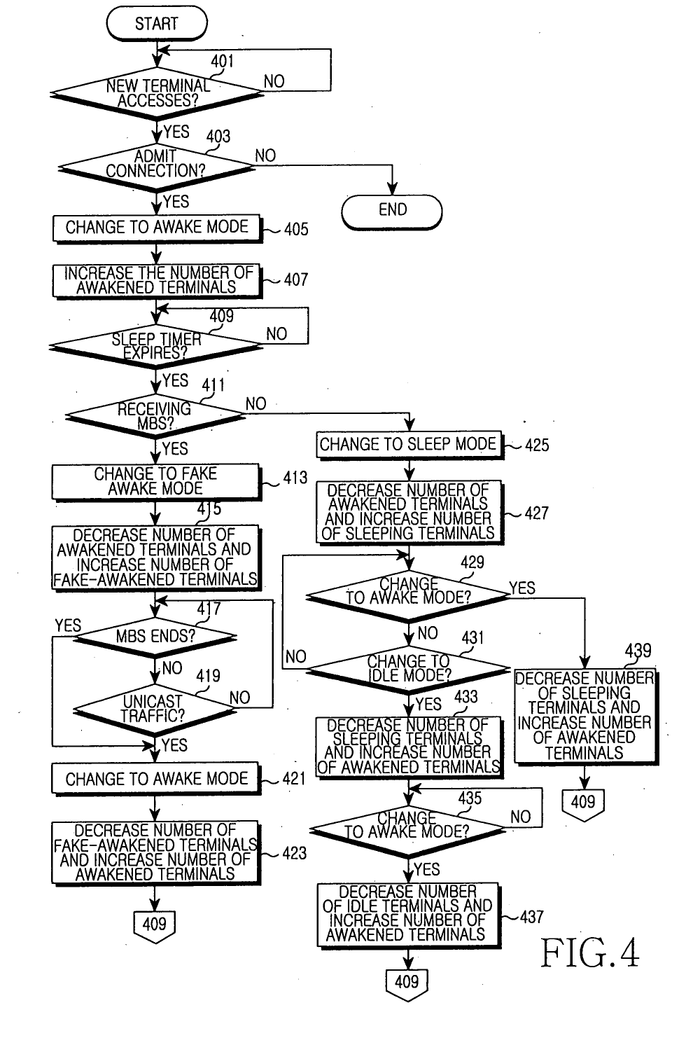

FIG. 4 is a flowchart of operations of the radio access station (RAS) in the broadband wireless access (BWA) system according to the present invention.

The RAS examines whether a new terminal accesses or not in step 401. When detecting the access of the new terminal, the RAS performs the CAC by taking into account the number of currently awakened terminals in step 403. When the terminal connection is not admitted; that is, when the number of awakened terminals exceeds the system capacity, the RAS rejects the access of the terminal and then finishes this process.

By contrast, when the terminal connection is admitted, the RAS changes the terminal state to the awake mode or the active mode in step 405. The awake mode signifies that the RAS and the terminal actually transceive data. In step 407, as the terminal enters the awake mode, the RAS increases the number of the awakened terminals by 1.

In step 409, the RAS examines whether the sleep timer for the unicast connection of the terminal expires. The sleep timer expires when there is no traffic for the unicast connection over a certain time. When the sleep timer expires, that is, when there is no traffic for the unicast connection of the terminal over a certain time, the RAS examines whether the terminal is receiving the MBS in step 411.

When the terminal is receiving the MBS, the RAS changes the terminal state from the awake mode to the fake awake mode in step 413. The fake awake mode is the mode for separately managing the terminals which receive only the MBS. In step 415, the RAS decreases the number of the awakened terminals by 1 and increases the number of fake-awakened terminals by 1.

In step 417, the RAS examines whether the MBS for the terminal is finished. When the MBS is not finished, the RAS determines whether a unicast traffic is generated for the terminal in step 419. When detecting the MBS termination, the RAS proceeds to step 421.

By contrast, when no unicast traffic is generated in step 419, the RAS goes back to step 417. When detecting the unicast traffic, the RAS changes the terminal state from the fake awake mode to the awake mode in step 421. In step 423, the RAS decreases the number of the fake-awakened terminals by 1 and increases the number of the awakened terminals by 1. Next, the RAS returns to step 407 to detect the expiration of the sleep timer in the awake mode.

When the terminal receives neither the unicast traffic nor the MBS in step 411, the RAS changes the terminal state from the awake mode to the sleep mode in step 425. In step 427, the RAS decreases the number of the awakened terminals by 1 and increases the number of sleeping terminals by 1.

Next, the RAS examines whether the terminal state is changed from the sleep mode to the awake mode in step 429. When the terminal enters the awake mode, the RAS decreases the number of the sleeping terminals by 1 and increases the number of the awakened terminals by 1 in step 439 and then goes back to step 409.

When the terminal does not enter the awake mode, the RAS examines whether the terminal state is changed from the sleep mode to the idle mode in step 431. When detecting no traffic in the sleep mode until the idle timer expires, the RAS enters the awake mode to release the radio section connection and then changes to the idle mode. The RAS examines this transition in step 431. When the terminal does not transit to the idle mode, the RAS goes back to step 429. When the terminal enters the idle mode, the RAS decreases the number of the sleeping terminals by 1 and increases the number of the idle terminals by 1 in step 433. In step 435, the RAS examines whether the terminal state returns to the awake mode. For example, in the idle mode, the terminal determines whether there is incoming traffic at regular time intervals. When the incoming traffic is detected, the RAS and the terminal re-enter the awake mode.

When the terminal enters the awake mode, the RAS decreases the number of idle terminals by 1 and increases the number of the awakened terminals by 1 in step 437, and then goes back to step 409.

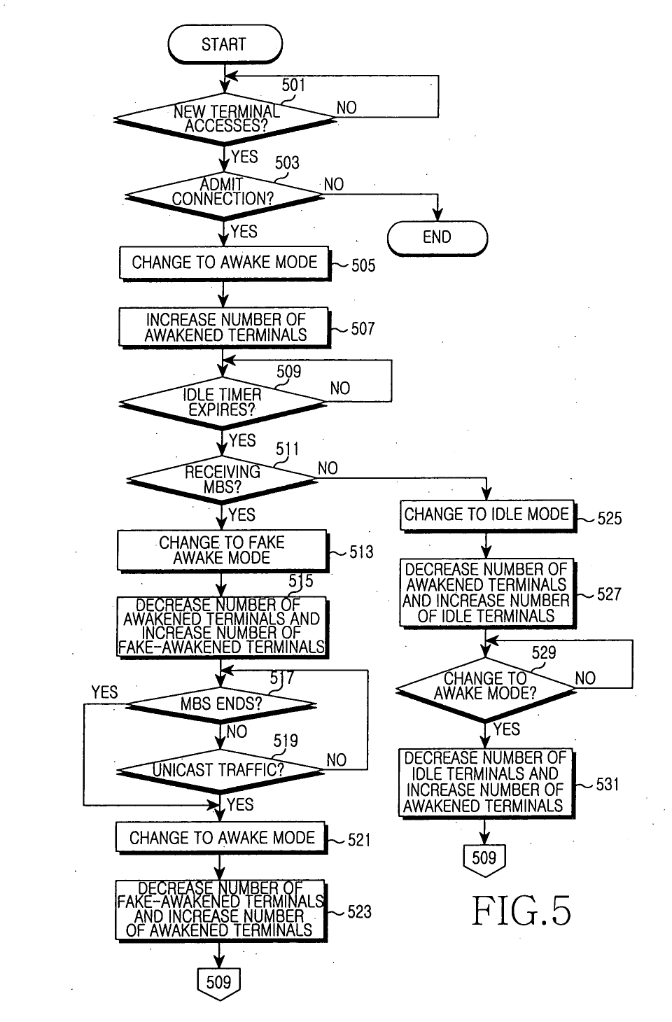

The operations of FIG. 4 are based on the state transition of FIG. 3. Yet, the actual operation of the RAS may not include the sleep mode (or the sleep timer). Hence, the operations without the sleep mode are now explained by referring to FIG. 5.

FIG. 5 is a flowchart of operations of the radio access station (RAS) in the broadband wireless access (BWA) system according to the present invention.

The RAS determines whether a new terminal accesses or not in step 501. When detecting the access of the new terminal, the RAS performs the CAC by taking into account the number of currently awakened terminals in step 503. When the connection for the terminal is not accepted; that is, when the number of the awakened terminals exceeds the system capacity, the RAS rejects the terminal access and then finishes this process.

By contrast, when the terminal connection is accepted, the RAS changes the terminal state to the awake mode or the active mode in step 505. The awake mode or the active mode signifies that the RAS and the terminal actually transceive data. In step 507, the RAS increases the number of awakened terminals by 1 because the terminal enters the awake mode.

In step 509, the RAS examines whether the idle timer for the unicast connection of the terminal expires or not. The idle timer expires when there is no traffic for the unicast connection over a certain time. When the idle timer expires, that is, when there is no traffic for the unicast connection of terminal over the certain time, the RAS determines whether the terminal is receiving the MBS in step 511.

When the terminal is receiving the MBS, the RAS changes the terminal state from the awake mode to the fake awake mode in step 513. The fake awake mode separately manages the terminals which receive only the MBS. In step 515, the RAS decreases the number of the awakened terminals by 1 and increases the number of fake-awakened terminals by 1.

Next, the RAS examines whether the MBS for the terminal is finished in step 517. When not detecting the end of the MBS, the RAS examines whether there is unicast traffic (uplink or downlink traffic) for the terminal in step 519. When detecting the end of the MBS, the RAS proceeds to step 521.

When not detecting the unicast traffic in step 519, the RAS goes back to step 517. When detecting the unicast traffic, the RAS changes the terminal state from the fake awake mode to the awake mode in step 521. In step 523, the RAS decreases the number of fake-awakened terminals by 1 and increases the number of awakened terminals by 1. Next, the RAS returns to step 509 to detect the expiration of the idle timer.

When the terminal receives neither the unicast traffic nor the MBS in step 511, the RAS changes the terminal state from the awake mode to the idle mode in step 525. In step 527, the RAS decreases the number of awakened terminals by 1 and increases the number of idle terminals by 1.

In step 529, the RAS examines whether the terminal state is changed from the idle mode to the awake mode. When the terminal enters the awake mode, the RAS decreases the number of idle terminals by 1 and increases the number of awakened terminals by 1 in step 531. Next, the RAS goes back to step 509.

As above, without the sleep mode in FIG. 5, the RAS examines whether the idle timer expires or not in the awake mode. When the idle timer expires, the RAS determines whether the terminal is receiving the MBS. When receiving the MBS, the terminal enters the fake awake mode. Not receiving the MBS, the terminal transits to the idle mode.

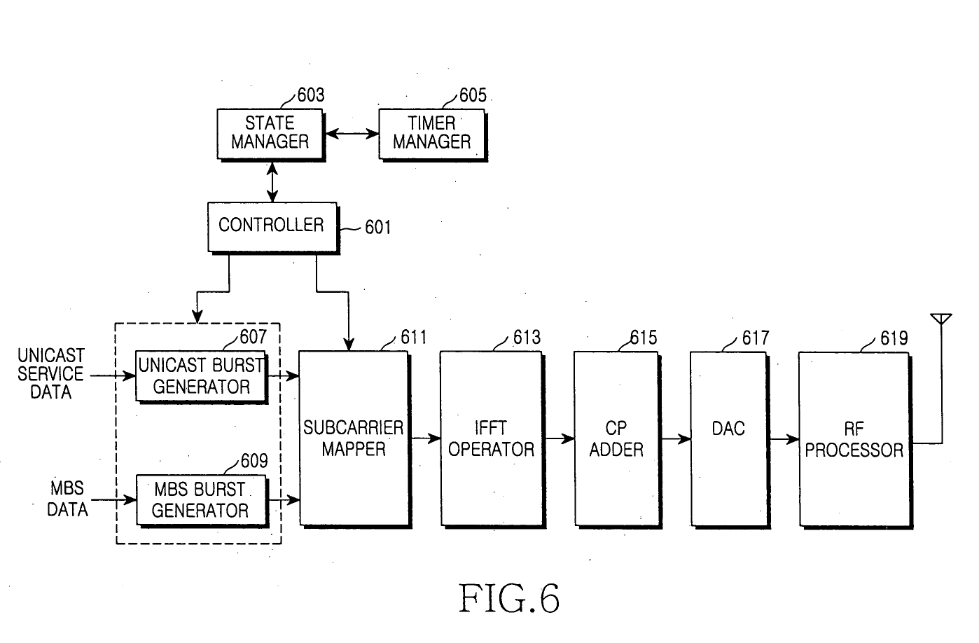

FIG. 6 is a block diagram of the radio access station (RAS) according to the present invention.

The RAS of FIG. 6 includes a controller 601, a state manager 603, a timer manager 605, a unicast burst generator 607, an MBS burst generator 609, a subcarrier mapper 611, an Inverse Fast Fourier Transform (IFFT) operator 613, a cyclic prefix (CP) adder 615, a digital-to-analog converter (DAC) 617, and a radio frequency (RF) processor 619.

The state manager 603 manages the mode (the state) of the accessed terminals individually according to the state transition of FIG. 3, and manages the number of terminals in each mode. The timer manager 605 manages the necessary timers in the state transition of FIG. 3. For instance, the timer manager 605 can operate a dormant timer (sleep timer or idle timer) for the individual terminal. The timer manager 605 drives the corresponding timer when a specific event is generated for the terminal. When the timer expires, the timer manager 605 notifies the state manager 603 of the timer expiration. Thus, when the timer expiration is informed, the state manager 603 can change the state of the corresponding terminal.

The controller 601 controls overall operation of the RAS. The controller 601 performs the CAC using the number of awakened terminals managed by the state manager 603. The controller 601 schedules the resources in association with the state manager 603. According to the scheduling result, the controller 601 controls the unicast burst generator 607, the MBS burst generator 609, and the subcarrier mapper 611.

The unicast burst generator 607 generates and outputs unicast bursts with incoming unicast service data. The unicast burst generator 607 can generate physical-layer bursts by collecting Media Access Control (MAC) Packet Data Units (PDUs), and code and modulate the bursts generated in the MAC layer with a Modulation and Coding Scheme (MCS) level according to the scheduling result.

The MBS burst generator 609 generates and outputs MBS bursts with MBS data (the broadcast contents) fed from the MBS controller 223. The MBS burst generator 609 can generate physical-layer bursts by collecting MAC PDUs, and code and modulate the bursts generated in the MAC layer with an MCS level according to the scheduling result.

The subcarrier mapper 611 maps the unicast bursts and the MBS bursts to the corresponding resources under the control of the controller 601 and outputs the mapped bursts. The IFFT operator 613 outputs time-domain data by IFFT-processing the data from the subcarrier mapper 611. The CP adder 615 appends a CP to the data from the IFFT operator 613. The DAC 617 converts the sample data from the CP adder 615 to an analog signal and outputs the converted analog signal. The RF processor 619 converts the baseband signal from the DAC 617 to an RF signal and transmits the RF signal over an antenna.

As set forth above, when there are terminals receiving the unicast service and terminals receiving the MBS, among the terminals actually transceiving traffic, a terminal receiving only the MBS is managed in the fake awake mode and the other terminals are managed as the awakened terminals. The present invention carries out the CAC based on the number of terminals actually receiving the unicast service (the number of awakened terminals). Therefore, even though the system is able to accept a new terminal, the access of the new terminal is rejected because of the terminals receiving only the MBS. In this situation, the access rejection of the new terminal can be avoided.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A terminal state managing method in a broadband wireless access (BWA) system, comprising:
examining whether a dormant timer of a terminal managed in an awake mode expires or not;
when the dormant timer expires, examining whether the terminal receives a broadcast service; and
when the terminal receives the broadcast service, managing the terminal in a fake awake mode.

2. The terminal state managing method of claim 1, wherein the dormant timer is a sleep timer or an idle timer.

3. The terminal state managing method of claim 1, wherein the dormant timer expires when there is no traffic for a unicast connection over a certain time.

4. The terminal state managing method of claim 1, further comprising:
when the broadcast service is finished or a unicast traffic is generated in the fake awake mode, managing the terminal in the awake mode.

5. The terminal state managing method of claim 1, further comprising:
performing a Connection Admission Control (CAC) based on a number of terminals managed in the awake mode.

6. The terminal state managing method of claim 1, further comprising:
when the terminal does not receive the broadcast service, managing the terminal in a sleep mode; and
when an idle timer expires in the sleep mode, managing the terminal in an idle mode.

7. The terminal state managing method of claim 1, further comprising:
when the terminal does not receive the broadcast service, managing the terminal in the idle mode.

8. The terminal state managing method of claim 1, wherein the broadcast service is a Multicast and Broadcast Service (MBS).

9. The terminal state managing method of claim 1, wherein a state transition of the terminal comprises at least one of a null mode, an awake mode, a fake awake mode, a sleep mode and an idle mode.

10. A base station (BS) for use in a broadband wireless access (BWA) system, comprising:
a timer manager for operating a dormant timer for terminals respectively; and
a state manager for managing a mode of the terminals, examining whether a corresponding terminal receives a broadcast service when the dormant timer expires, and managing the terminal in a fake awake mode when the terminal receives the broadcast service.

11. The base station of claim 10, wherein the dormant timer is a sleep timer or an idle timer.

12. The base station of claim 10, wherein the dormant timer expires when there is no traffic for a unicast connection over a certain time.

13. The base station of claim 10, wherein, when the broadcast service is finished or a unicast traffic is generated in the fake awake mode, the state manager manages the terminal in the awake mode.

14. The base station of claim 10, further comprising:
a controller for performing a Connection Admission Control (CAC) based on a number of terminals managed in the awake mode when an access of a new terminal is detected.

15. The base station of claim 10, wherein the state manager manages the terminal in a sleep mode when the terminal does not receive the broadcast service, and manages the terminal in an idle mode when an idle timer expires in the sleep mode.

16. The base station of claim 10, wherein the state manager manages the terminal in an idle mode when the terminal does not receive the broadcast service.

17. The base station of claim 10, wherein the broadcast service is a multicast and broadcast service (MBS).

18. The base station of claim 10, further comprising:
a controller for scheduling resources in association with the state manager;
a first generator for generating unicast bursts according to the scheduling result;
a second generator for generating broadcast service bursts according to the scheduling result;
a resource mapper for mapping the bursts from the first generator and the second generator to the resources;
an operator for orthogonal frequency division multiplexing (OFDM)-modulating the data from the resource mapper; and
a radio frequency (RF) processor for converting the data from the operator to an RF signal and transmitting the RF signal.

19. An operating method of a base station (BS) in a broadband wireless access (BWA) system, the method comprising:
classifying terminals receiving only a broadcast service to a fake awake mode and other terminals to an awake mode among terminals having traffic flow; and
when an access of a new terminal is detected, determining whether to admit a connection based on a number of terminals in the awake mode.

20. The operating method of claim 19, wherein the classifying comprises:
examining whether a dormant timer expires with respect to the individual terminal;
when the dormant timer expires, examining whether a corresponding terminal receives the broadcast service; and
when the terminal receives the broadcast service, classifying the terminal to the fake awake mode.

21. The operating method of claim 20, wherein the dormant timer is a sleep timer or an idle timer.

22. The operating method of claim 20, wherein the dormant timer expires when there is no traffic for a unicast connection over a certain time.

23. The operating method of claim 20, wherein the classifying further comprises:
when the terminal does not receive the broadcast service, classifying the terminal to a sleep mode; and
when an idle timer expires in the sleep mode, classifying the terminal to an idle mode.

24. The operating method of claim 20, wherein the classifying further comprises:
when the terminal does not receive the broadcast service, classifying the terminal to an idle mode.

25. The operating method of claim 20, wherein the classifying further comprises:
when the broadcast service is finished or a unicast traffic is generated in the fake awake mode, classifying the terminal to the awake mode.
